(19) United States
(12) Patent Application Publication
(10) Pub. No.: US 2026/0127781 A1
(43) Pub. Date: May 7, 2026

(54) LEVERAGING GENERATIVE MODELS FOR EFFICIENT DESIGN AND MANUFACTURING OF PRODUCTS

(71) Applicant: Shaw Industries Group, Inc., Dalton, GA (US)

(72) Inventor: Julian Cole, Blackpool (GB)

(21) Appl. No.: 19/368,203

(22) Filed: Oct. 24, 2025

Related U.S. Application Data
(60) Provisional application No. 63/715,869, filed on Nov. 4, 2024.

(51) Int. Cl. G06T 11/00; G06N 20/20

(52) U.S. Cl. CPC G06T 11/00; G06N 20/20

(57) ABSTRACT

A system and method are presented for generating a design based on a prompt. The prompt can be a text prompt or an image prompt. An image generating model is trained on a database of images. The image generating model includes at least one hyperparameter. The prompt is submitted to the model along with the hyperparameter. The model generates a set of images, one of which is selected for further processing. The processed image is converted into a production specification which can be used as a direct input to control a manufacturing process of the product.

### CROSS-REFERENCE TO RELATED APPLICATIONS

This application claims the benefit of priority to U.S. Provisional Application No. 63/715,869, filed on November 4, 2024, the contents of which are hereby incorporated by reference.

### BACKGROUND

Designing a manufactured product can be time and resource intensive because the design process generally calls for expertise and often multiple iterations between the designer and the customer. Typically a designer generates multiple designs, which are then evaluated by the customer who provides feedback that the designer uses to update the design. This cycle consumes many hours of work and also may require special expertise or resources. Even after the appearance of the design has been agreed upon, the design may not easily correlate with what a manufacturing tool can generate. Thus, additional re-designs may be required to accommodate both the customer and the available manufacturing tools. This entire process thus consumes significant time and resources before a manufacturable design can be submitted to a manufacturing line for production.

### SUMMARY

This disclosure is directed to systems and methods for enabling resource efficient generation of product designs that can be readily manufactured using manufacturing machines. This disclosure uses flooring products as an example of the products that can be designed and manufactured using the systems and methods described herein. The present disclosure is not limited to flooring products and one skilled in the art will appreciate that the same techniques can be leveraged in the design and manufacture of other types of products (e.g., furniture, wallpaper, vehicles, appliances, clothing, etc.).

A method is described herein for generating an image, a production specification, and a to-be-manufactured product. The method includes receiving a request to generate an image corresponding to a design of a to-be-manufactured product. The request includes a prompt indicating attributes of the image. The method includes generating, using a generative machine learning model and using the prompt as an input, a plurality of images. The method includes selecting an output image among the plurality of images as the design of the to-be-manufactured product. The method includes mapping aspects of the output image to a production specification corresponding to the to-be-manufactured product. The method includes generating, by a manufacturing tool, the to-be-manufactured product using the production specification.

The generation of a plurality of images and selecting the output image can include submitting the prompt to a first generative machine learning model and generating, using the first generative machine learning model and using the prompt as an input, a first plurality of images. The method can include selecting a first image among the first plurality of images. The method can include generating, using a second generative machine learning model, a second plurality of images based on the first image and selecting the output image from the second plurality of images.

The first and second generative machine learning models can include diffusion models trained using a plurality of training images and wherein the plurality of training images comprises product images from a product catalog and public images corresponding to publicly accessible images. The request can include a first hyperparameter of the first or second generative machine learning model, and wherein the first hyperparameter is submitted to the first or second generative machine learning model along with the prompt to generate the first or second plurality of images. The first hyperparameter can include at least one of a number of steps for a sampling method or a creativity level. The creativity level corresponds to a distance metric between an encoding of the prompt and an image encoding of each image of the first or second plurality of images.

The method can include determining a second hyperparameter for the second generative machine learning model, submitting the first image and the second hyperparameter to the second generative machine learning model, and generating, by the second generative machine learning model and based on the first image and the second hyperparameter, the second plurality of images. The second hyperparameter can include a noise level, and wherein the noise level determines an amount of noise added to the first image by the second generative machine learning model when generating the second plurality of images. The prompt can include at least one of a text prompt or an image prompt.

The to-be-manufactured product can be a carpet tile and the production specification can include data for attributes of the carpet tile including, for each pixel of the output image, at least one of a yarn type, a yarn color, a pile type, and a pile height. The production specification can further include a tufting tool, a cutting tool, a cut list, a tile shape, a tile dimension, and an overall dimension.

A system for producing a production specification and a to-be-manufactured product is described. The system includes a production server, a manufacturing control server, and an image generator. The image generator is configured to receive a request comprising a prompt indicating attributes of an output image, to generate, using a generative machine learning model with the prompt as an input, a plurality of images, and to select the output image from the plurality of images. The production server is configured to map aspects of the output image to the production specification corresponding to the to-be-manufactured product. The manufacturing control server is configured to generate, by one or more manufacturing tools, the to-be-manufactured product using the production specification.

Other systems, devices, methods, features and advantages of the subject matter described herein will be or will become apparent to one with skill in the art upon examination of the following figures and detailed description. It is intended that all such additional systems, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF FIGURES

The details of the subject matter set forth herein, both as to its structure and operation, can be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes can be illustrated schematically rather than literally or precisely.

FIG. 1 illustrates an environment in which the method is performed.

FIG. 2A illustrates an example flow chart describing the method.

FIG. 2B illustrates an example flow chart describing the method.

FIG. 3 illustrate an example user interface showing details of the system.

FIG. 4 illustrates an example intermediate output of the method (first generated image).

FIG. 5 illustrates an example user interface with additional details.

FIG. 6 illustrates an example intermediate output of the method (second group of images and the output image).

FIG. 7 illustrates an example of image processing.

FIG. 8 illustrates an example of intermediate output (repeated tiling of image).

FIG. 9 illustrates an example of demonstration floorplan.

FIG. 10A illustrates an example process flow.

FIG. 10B illustrates an example process flow

FIG. 11 illustrates a computing device.

### DETAILED DESCRIPTION

The product design process can be resource intensive and time consuming. By streamlining the design process, these limitations can be overcome. In addition, the iterations for producing the desired design can be integrated with automated manufacturing to make more effective use manufacturing tools including reducing idle time. The design process can be streamlined using artificial intelligence (AI) systems. For example, and as described throughout this document, generative AI models can be used to generate images faster and in a more resource efficient manner relative to a human designer drawing (e.g., using design tools) new designs, and can enable more efficient transfer of a new design to manufacturing.

The system includes an image generator for generating one or more design images and a production specification generator for generating a production specification based on a particular generated design output image (e.g., generated using the image generator). The production specification specifies data for multiple attributes of a to-be manufactured product that can then be used by a production control or manufacturing system to automatically fabricate or manufacture a product with the generated design and corresponding production specification.

During operation of the system, a user (e.g., a product designer) can enter a prompt (e.g., a text phrase or an image) via a front-end interface (e.g., of a design software), with the prompt specifying, for example, an inspirational image or an inspirational phrase. The prompt is provided as an input to a generative model (e.g., a text-to-image model or an image-to-image model), which generates a set of images based on the entered prompt. The system provides the generated set of images for display on the front-end interface.

From among the group of generated images, an output image can be selected for further processing. For example, upon being presented with the group of images generated by the generative model, the user can select an image. Alternatively, the system can be configured to automatically select one of the generated images. For example, the system can rank each of the generated images according to some score and then select the top-scored image. An example score can be based on color mapping if, for example, the prompt included a main color or a set of colors to be included in the generated image. Another example score can be a score based on a similarity between an embedding of the prompt with an embedding of each of the generated images.

With respect to the selected output image, the front-end interface can be configured to provide the user to modify one or more model hyperparameters. In an example, the user can specify a certain level of noise to the image generating model to produce a second set of images based on the selected image. In another example, the user can increase or decrease the creativity hyperparameter. The specified model hyperparameters are then used by an image-to-image generative model to generate a second set of images from the selected image. A second image is then selected (e.g., manually by the user or automatically by the system) from this second set of images as the output image.

The output image is then processed by a production specification generator to convert it into a production specification, which can then be used to manufacture the product. The production specification generator receives the output image file and can process the output image file. The production specification generated based on the output image can, optionally or additionally, include metadata related to a fabrication process while also including details for each pixel of the output image

Metadata related to the entire workpiece can, for the flooring product example, include, for example, a number of repeats in the X and Y directions, the shape of tile, tile dimensions, overall product dimensions, a tufting tool(s), a cutting tool(s), a cut list, and a tile shape. Example details per pixel for a flooring product can include a yarn type, a yarn color, a yarn diameter, a pile type, and a pile height.

In an example of flooring products, the output image can be processed to produce a template for manufacturing the flooring piece and also to display the actual look and feel of a flooring piece to a user prior to fabrication. In an example, the output image can have a color palette not attainable with yarn present in a warehouse, so the production specification generator can be configured to reduce the color palette of the image to colors of existing/available yarn. Alternatively, the client or designer can view the resulting second image in a reduced color palette of 2, 4, or any number of colors to decide whether the additional expense or time produces a more desired result. Additionally, the output image can be mapped onto existing or available inventory of products and associated colors (e.g., the yarn colors in the context of flooring products). The output image can be processed in various other ways, including, for example, scaling down the output image or scaling up the output image by reducing or increasing the number of pixels involved. The output image can be reconfigured so that it is displayed as a set of tiles repeated next to each other. For example, the output image can be displayed with N repeats in the X-direction and M repeats in the Y-direction to provide the designer/user with an image of how a full floor area covered by these tiles would look.

The production specification generator can output a file with a product number for a new pattern to be stored in a database. The production specification generator can include several different methods of storing or displaying the pattern. For example, the pattern can be included in a standard brochure of flooring product along with a simulation of furniture placed on top of the flooring product for display to a customer or user. The production specification generator can output an image file in different formats (e.g., jpg, png, pdf, zip etc).

The production specification can be provided to a manufacturing tool or tools to manufacture the product. For example, the production specification can include a series of specific instructions for each of the manufacturing tools used to manufacture the product. The specific instructions can include specifying particular colors or types of materials to be used as well as recipes for executing the manufacturing process. In the case when multiple machines are used for manufacturing the product, each machine is identified so that it receives the specific instructions and is not improperly receiving instructions for another machine. In an example of an integrated manufacturing line a workpiece may be passed from one manufacturing tool to another manufacturing tool automatically so that when receiving the production specification, each manufacturing tool understands which instructions it is to execute, in what order, and under what conditions.

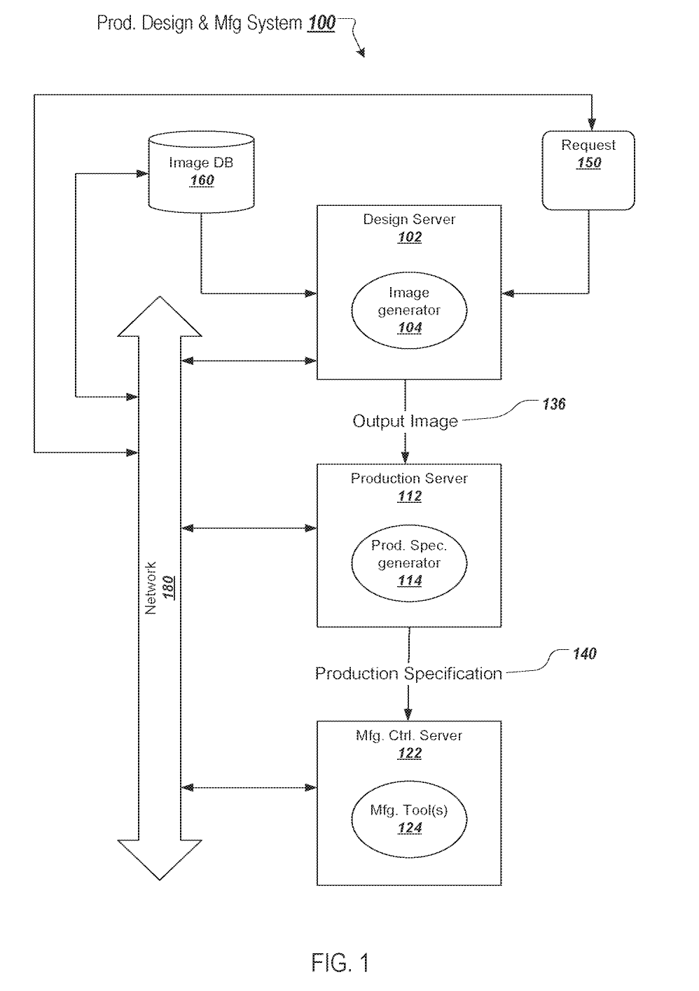

FIG. 1 illustrates an example environment in which a production design and manufacturing system 100 can operate and in which a method may be performed. A design server 102 has access to an image database 160 (also image DB) and receives a request 150 to generate an image (or images) for a design. The design server 102 includes an image generator 104. The image generator 104 can be a piece of software, a piece of hardware, or a mixture of both hardware and software. The design server 102 receives a request 150 for a new design and generates an image. As explained in more detail elsewhere in this disclosure, the generation of the image can include several cycles back and forth with a designer or the entirety of the generation can be performed by the production design and manufacturing system 100. The image generator 104 generates an output image 136 which is submitted to the production server 112. The production server 112 includes a production specification generator 114 which receive the output image 136 and generates a production specification 140. The production specification 140 provides information for manufacturing the product. The production specification 140 is submitted to the manufacturing control server 122. The manufacturing control server 122 controls various manufacturing tools 124. Example manufacturing tools 124 include tufting machines, cutting machines, and the like. Upon receipt of the production specification 140, the manufacturing control server 122 can control the manufacturing tools 124 to fabricate the product according to the product specification. Communication among the components of the production design and manufacturing system 100 can take place through direct connections or over a network 180.

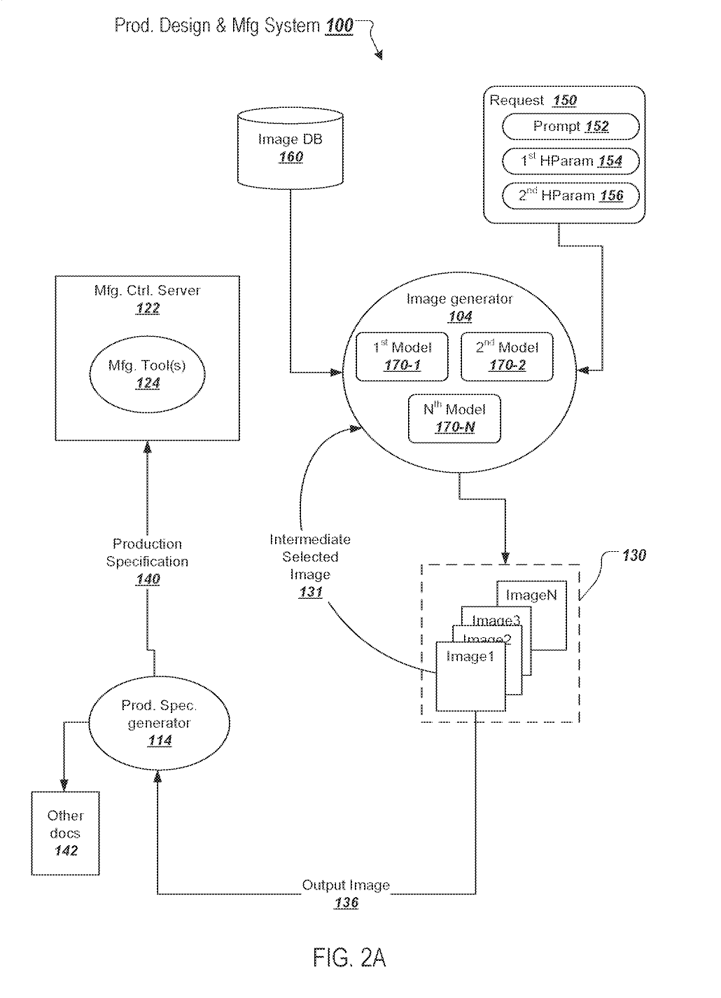

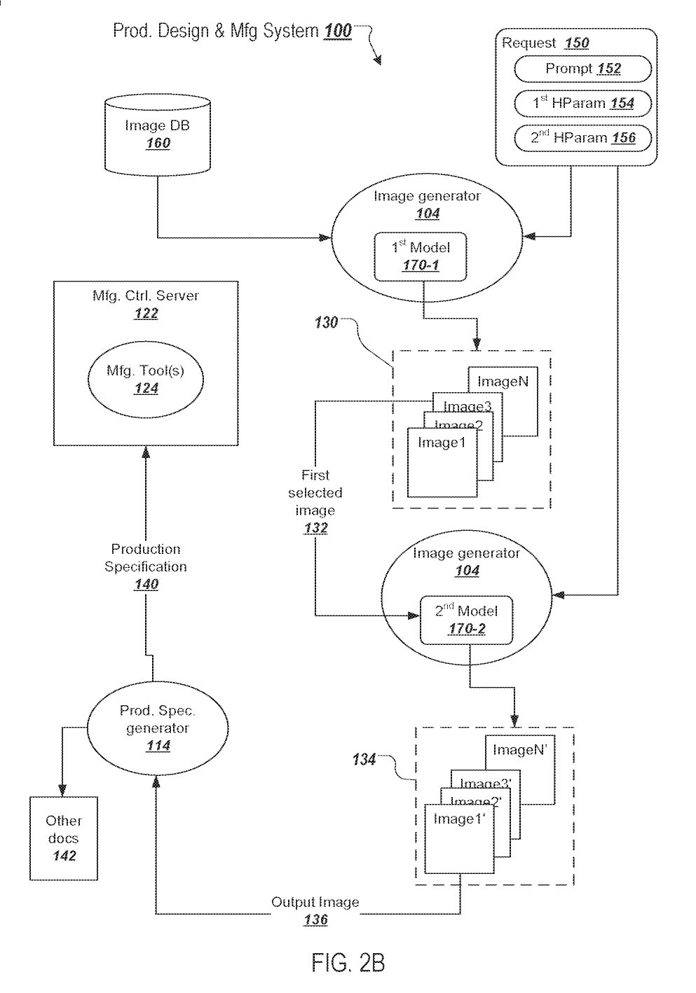

FIG. 2A and FIG. 2B illustrate some additional details of the production design and manufacturing system 100. The image DB 160 includes a large number of images with additional information (e.g., labels, categories, intellectual property details, qualifications, and other metadata). The images in the image DB 160 are used to train a model in the image generator 104 to generate additional images, such as a first group of images 130 or a second group of images 134. The image DB 160 includes a group of training images which includes product images from a product catalog and public images corresponding to publicly accessible images. The image generator 104 receives a request 150 to generate images. The request 150 includes a prompt 152 and can, optionally, include one or more hyperparameters for tuning the generative machine learning model of the image generator 104 (e.g., first hyperparameter 154, second hyperparameter 156, third hyperparameter 158, etc.). The prompt 152 indicates attributes of the image(s) to be generated. The prompt 152 can include text, an image, an audio file, etc. The prompt can include a text prompt or an image prompt. An example prompt 152 is a phrase (e.g., “red and black geometric shapes, mostly triangles and circles” or “a seamless pattern using square shapes”). Another example prompt 152 is an image such as an image of a flower. A prompt 152 can include combination of text, images, audio files, and the like.

The image generator 104 includes one or more models for generating images from a request 150, for example, one or more generative machine learning models. The image generator 104 can include a first generative machine learning model 170-1, a second generative machine learning model 170-2, up to an N^{th} generative machine learning model 170-N. Prior to receiving the request 150 with the prompt 152, the one or more models of the image generator 104 are trained using the image DB 160 to create one or more trained generative machine learning models (e.g., first generative machine learning model 170-1, second generative machine learning model 170-2, etc.). Using the prompt 152 as an input, the image generator 104 uses the trained generative machine learning model(s) (e.g., first to Nth models 170-1 to 170-N) to generate a group of images (e.g., first group of images 130, second group of images 134, etc.).

The model(s) can include parameters (e.g., internal parameters) which are varied during the training phase. The model can include hyperparameters which are not varied during the training phase but which are provided externally to the model. In an example, a request 150 (e.g., the request illustrated in FIG. 2A), includes a prompt 152, a first hyperparameter 154 and a second hyperparameter 156. Each of the prompt 152, the first hyperparameter 152 and the second hyperparameter 154 is submitted to the image generator 104 to generate a group of images using the one or more models. The number of hyperparameters is not limited to two and can include any number of hyperparameters including no hyperparameters or one hyperparameter (e.g., a first hyperparameter) only. The first hyperparameter 154 can be submitted to the image generator 104 along with the prompt 152 to generate the first group of images 130. In some implementations, a second hyperparameter 156 is determined and the second hyperparameter 156 is also provided to the image generator 104 along with the first hyperparameter 154 to generate the first group of images 130 and also to generate the second group of images 134. In some implementations, the second hyperparameter 156 is determined and provided to the image generator 104 along with the first selected image 132 to generate the second group of images 134. In some implementations the second hyperparameter 156 is only used to generate the second group of images 134. In other implementations, the second hyperparameter 156 is used along with the first hyperparameter 154 to generate both the first group of images 130 and the second group of images 134. Any hyperparameters 154, 156 may be provided to the image generator 104 at any stage of the process for use with any of the models.

In some implementations, the generative model can be trained on a labelled set of images prior to being used by the designer. The set of labelled images can include proprietary images from a database (e.g., images from a product catalog corresponding to products already being manufactured by one or more entities) as well as other, non-proprietary images. For example, a diffusion model may be used. As part of the process the user can also adjust at least one hyperparameter (e.g., an externally adjustable parameter) from the model for producing the images. Example hyperparameters include “creativity,” “steps,” and “noise. A creativity hyperparameter can represent, for example, a distance metric between an encoding of the prompt and an encoding of each of the generated images. A larger creativity hyperparameter permits the generative model to generate images which are significantly more different from the prompt than a lower creativity hyperparameter. A steps hyperparameter can give the number of iterations a generative model may operate on the prompt as part of generating the images. In an example of a diffusion model, the steps hyperparameter may indicate the number of iterations for refining an image from the initial image of randomly valued pixels. A noise hyperparameter may represent the amount of noise added to an image used as the prompt in refining or generating a new group of images. The user can also specify the size of the resulting image—for instance how many pixels wide and how many pixels long the image can be.

FIG. 2A illustrates a cyclical or iterative process. The image generator 104 receives the request 150. The image generator 104 submits the prompt 152 and any hyperparameters to the first generative machine learning model 170-1, which generates a group of images 130. From the group of images 130, an intermediate image 131 is selected (e.g., Image1) and sent back to the image generator 104. The image generator 104 receives the selected intermediate image 131 and submits that along with the prompt 152 and any hyperparameters to the second generative machine learning model 170-2. This produces a second group of images. From this second group of images, a second intermediate image is selected and sent back to the image generator 104 (e.g., to the same generative model or another generative model of the image generator 104). This cycle of submission of a selected intermediate image 131 to the image generator 104, using a same or next generative machine learning model based on the prompt 152, any hyperparameters and the selected intermediate image 131 to produce a new group of images 130 can continue until a cessation condition is met and the output image 136 is selected for transmission to the production specification generator 114. An example cessation condition is after a set number of iterations. Another example cessation condition is that a user decides enough iterations have elapsed. Other cessation conditions can also be used and the condition evaluation can be automated (e.g., when a similarity calculation between the currently selected intermediate image and the previously selected intermediate image exceeds a threshold value).

The implementation of the production design and manufacturing system 100 illustrated in FIG. 2B shows an example when two cycles of image generation occur and from the second group of images, the output image is selected. In FIG. 2B, the image generator generates a first group of images 130 and a second group of images 134, but this number is an example only and any number of groups of images may be generated, as noted in the previous paragraphs. In the example illustrated in FIG. 2B, the image generator, based on the request 150 generates a first group of images 130 (e.g., Image1, Image2, Image3, … ImageN) using the first generative machine learning model 170-1. From this first group of images 130, a first image is selected 132 (e.g. Image3). This first selected image 132 is then sent to the second generative machine learning model 170-2 of image generator 104. The second generative machine learning model 170-2 also has access to the request 150, which can include hyperparameters. The second generative machine learning model 170-2 generates a second group of images 134 (e.g., Image1’, Image 2’, … ImageN’) based on the first selected image 132 and the request 150. In the example, from the second group of images 134, the output image 136 is selected and sent to the production specification generator 114.

For each generation of images by the image generator 104, an additional model can be used and also an additional hyperparameter (e.g., first hyperparameter 154) or hyperparameters (e.g. first hyperparameter 154 and second hyperparameter 156), can be included. In some implementations, the generative machine learning models can all be the same model. In some implementations the hyperparameters 154, 156 used in each iteration are the same, but the hyperparameters have different values with each iteration. For example, in generating the first group of images 130, the image generator 104 can receive a first hyperparameter 154 (e.g., a creativity level or a number of steps for a sampling method for a diffusion model to evolve away from an initial image of randomly valued pixels) with a large value so that the first group of images 130 can be very different from the prompt 152. In generating the second group of images 134, the first hyperparameter 154 (e.g. creativity) can have a smaller value than that used for generating the first group of images 130 so that the second group of images 134 is more similar to the first selected image 132 than is the prompt 152 to the first group of images 130. In generating the second group of images 134, the image generator 104 can include a second hyperparameter 156 (e.g., “steps”) which was not included in the generation of the first group of images 130. In an example, the first hyperparameter 154 is a creativity level representing a distance metric between an encoding of the prompt 152 and an encoding of each of the images of the first group of images 130 or the second group of images 134. In this example, the creativity level thus sets a measure for how different each of the group of images is permitted to be relative to the prompt 152.

The image generator 104 receives the request 150 with the prompt 152. The image generator 104 produces a first group of images 130 using the first model 170-1. The example of FIG. 2B shows four images, but any number can be generated. From among the images of the first group of images 130, the image generator selects a first image 132. In the example, the image generator 104 selects Image3 and sends that image to the image generator 104 to the second model 170-2 and optionally also with an additional hyperparameter or with different hyperparameter values. The image generator 104 can also receive the entire request 150 with the selected image including any hyperparameters 154, 156 or the original prompt 152. The image generator 104 generates a second group of images 134 based on the first selected image 132 and the request 150. From the second group of images 134, the image generator 104 selects an output image 136. In the example shown in FIG. 2B, ‘Image1’ is selected as the output image 136. Although the above descriptions provide for the iterative generation of images via one or more models, in some implementations, a single iteration may be performed such that the selected image from among various generated images is transmitted to the next entity in the processing pipeline (e.g., the production specification generator 114).

The output image 136 is transmitted to the production specification generator 114. The production specification generator 114 generates a production specification 140 based on the output image 136. The production specification generator 114 maps aspects of the output image 136 to a production specification 140. The production specification generator 114 receives the output image 136 and can modify or process the output image 136 in several ways. As one example, the production specification generator 114 can modify the output image 136 to reduce the number of colors available to those associated with a particular one of the manufacturing tools 124 (e.g. a particular tufting machine can have only 4 yarn colors available). In another example, the overall product size (e.g., the number of tufts in each of the X and Y directions) which differ from the number of pixels in each direction in the output image 136. The production specification generator 114 can thus have rules for mapping the output image 136 of a certain pixel size onto an overall product of a different size or different number of pixels. In some examples, after fabricating one large intermediate piece on a large production tool, that large intermediate piece is cut into smaller pieces that form the end product. In such examples, a cutting tool can be specified and a set of instructions for the cutting tool can be generated as part of the production specification 140 using the production specification generator 114. For the example of a cutting tool, the production specification 140 can include how the large intermediate piece can be aligned to the cutting blade, along with a list of motions of the large piece and a list of motions of the blade (e.g., a cut list).

The production specification generator 114 generates a production specification 140 and other documents 142. The production specification 140 includes the information necessary to fabricate the product. The production specification generator 114 can also produce other documents 142 related to the output image, for example, a demonstration brochures illustrating the flooring product with simulated lighting or next to other objects (e.g., how furniture will appear on top of a carpet tiles). The production specification generator 114 transmits the production specification to the manufacturing control server 122.

The manufacturing control server 122 receives the production specification 140. The manufacturing control server 122 controls various manufacturing tools 124 based on the production specification 140. The manufacturing control server 122 may receive information from the production specification 140 about the manufacturing tools 124 to be used. The manufacturing control server 122 controls manufacturing tools 124 to generate a product using the production specification 140. The manufacturing control server 122 can store information about the various manufacturing tools 124 such as configuration settings, tool scheduled availability, maintenance logs, tool limitations (e.g. maximum size of a production piece the tool can operate on), tool optimized operating conditions, and the like. In an example for a carpet tile, the production specification 140 includes data for attributes of the carpet tile including, for each pixel of the output image, at least one of a yarn type, a yarn color, a yarn material, a pile type, and a pile height pile. For the example of carpet tile, the production specification also includes a tufting tool, a cutting tool, a cut list, a tile shape, a tile dimension, and an overall dimension and can include specific details related to the tufting machines and the cutting machines. The manufacturing control server 122 can receive the production specification 140, and taking into account the information the manufacturing control server 122 has stored, it will generate specific commands to be executed by the manufacturing tools 124 to fabricate the product.

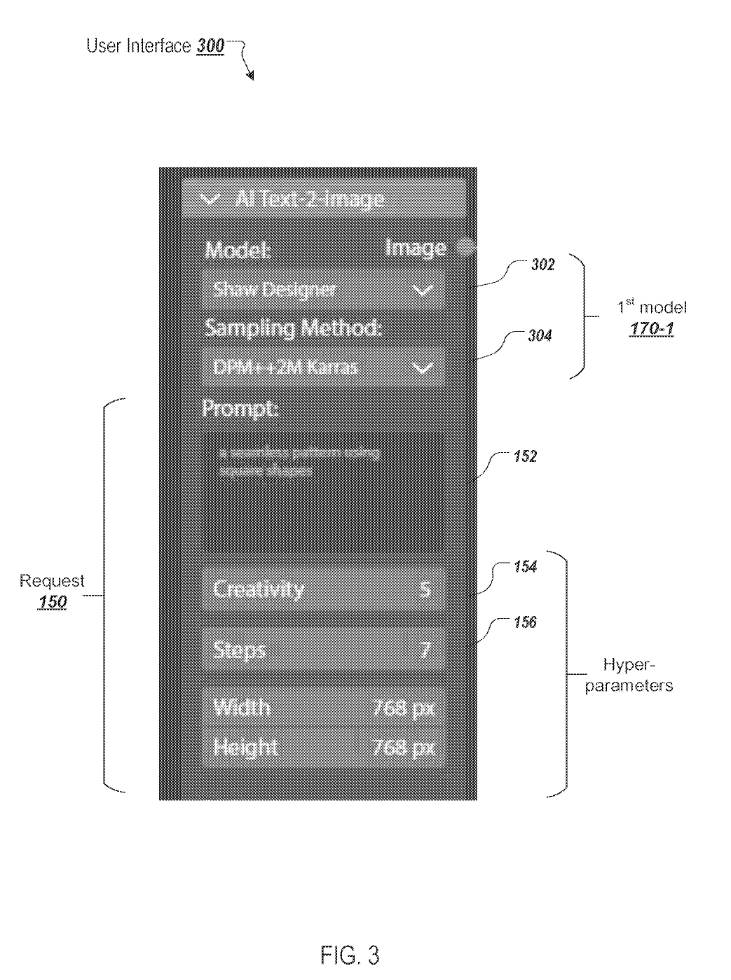

FIG. 3 illustrates an example of a request 150 to be submitted to the image generator 104. The request 150 is shown as part of a user interface 300 of the production design and manufacturing system 100 for modifying or adjusting the request 150. The example user interface 300 allows a user to select an image generating model 302, a sampling method 304, a prompt 152, a first hyperparameter 154 (e.g., a creativity level), a second hyperparameter 156 (e.g., number of steps), and the dimensions (width and height) of the images to be generated. The example request 150 shows that the output image has the same width as height (in pixels), but implementations can also include alternative shapes such as, for example, rectangles, triangles, or hexagons with different dimensions. This example user interface 300 shows a prompt 152 for a text-to-image generator. An alternative request 150 could include an image as the prompt 152 or a combination of an image and text as the prompt 152. In this example, the UI 300 shows pulldown menus for selecting alternative generative machine learning models 170-1, … 170-N, and one model can be selected for each iteration of generating a group of images.

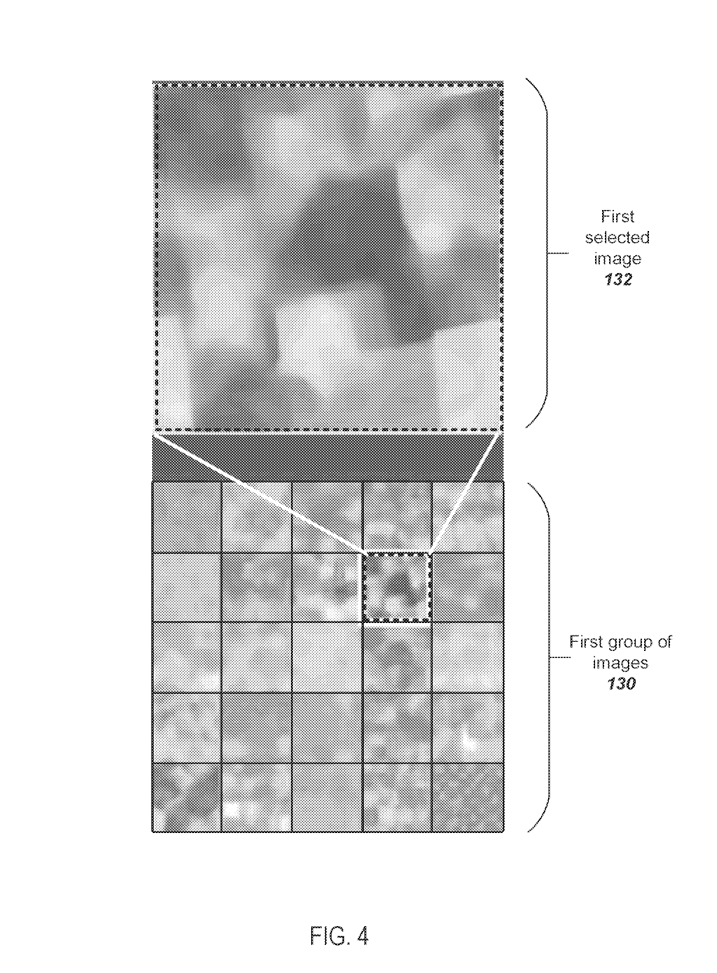

When input into the image generator 104, the example prompt 152 and hyperparameters 156, 156, and image dimensions from FIG. 3 produces a first group of images 130, as illustrated in FIG. 4. In this example, the first selected image 132 is highlighted by the dashed line in the first group of images 130. A user can select any image of the first group of images 130 as the first selected image 132. The production design and manufacturing system 100 can also select one of images of the first group of images 130 as the first selected image 132. In an example, the first selected image 132 can be used as the output image 136. In other examples, the first selected image 132 can be entered as a prompt 152 or as part of the prompt into the image generator 104 to generate a second group of images 134 using the second generative machine learning model 170-2. The first group of images 130 show a wide variety in the color scheme, but all align well with the example initial text prompt 152 (e.g., “a seamless pattern using square shapes”).

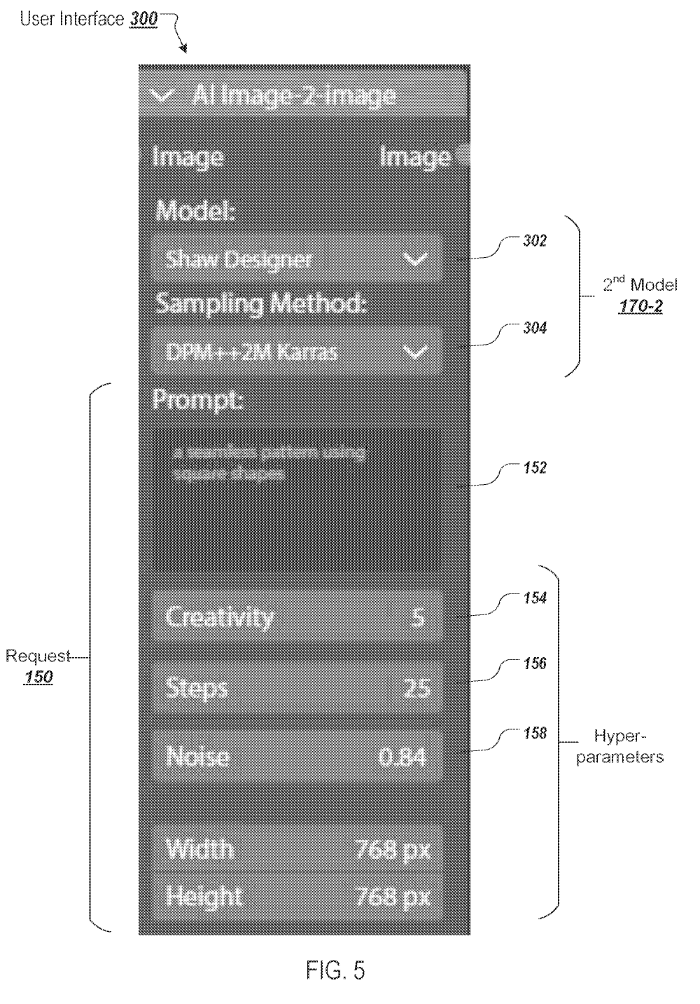

To further refine the design, a new group of images can be generated by using a modified request or by accessing some of the hyperparameters for the image generator 104, which were not used in the generation of first group of images. FIG. 5 illustrates such an example request 150 using the user interface 300 of the production design and manufacturing system 100. In this instance the image generator 104 uses the second generative machine learning model 170-2 to generate a second group of images 134. In this example the second generative machine learning model 170-2 is the same as the first generative machine learning model 170-1, but the models at each iteration can differ (e.g., one can be a text-to-image model, another can be an image-to-image model). This modified request 150 shows a third hyperparameter 158 (“noise”) to be used in generating the second group of images 134 in addition to the first hyperparameter 154 (“creativity”) and the second hyperparameter 156 (“steps”) which were also used to generate the first group of images 130. In this example, the first hyperparameter 154 retains the same value as used when generating the first group of images 130 but the second hyperparameter 154 uses a larger value. In an example, the noise hyperparameter 158 determines an amount of noise (e.g., a random signal) added to the first selected image 132 by the generative machine learning model (e.g., the image generator 104) to generate the second group of images 134.

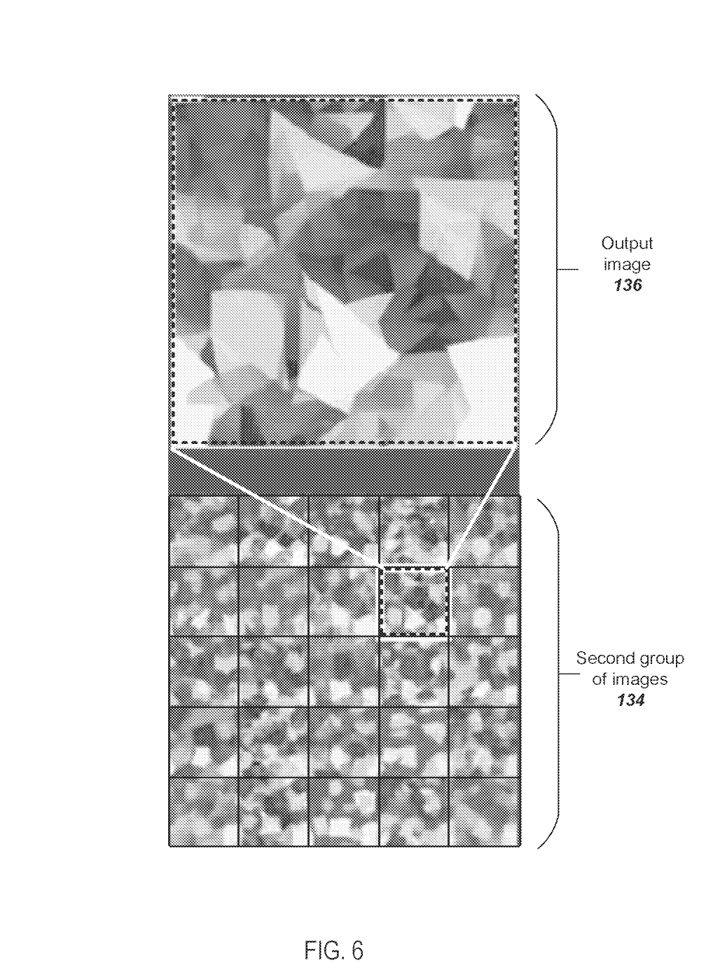

The second iteration of the image generator 104, using the first selected image 132 along with the example request 150 of FIG. 5 results in the second group of images as illustrated in FIG. 6. This example second group of images 134 generated by the second generative machine learning model 170-2 of the image generator 104 has a narrower color palette than the example the first group of images 130. In the example, the selected output image 136 is highlighted by the dashed line in the second group of images 134. A user can select any image of the second group of images 134 as the output image 136 or the production design and manufacturing system 100 can automatically select the output image 136. While the examples shown above illustrate two cycles for the selection of an output image 136, more than two cycles can be employed with multiple models and also with variations of any of the hyperparameters. The output image 136 is submitted to the production specification generator 114.

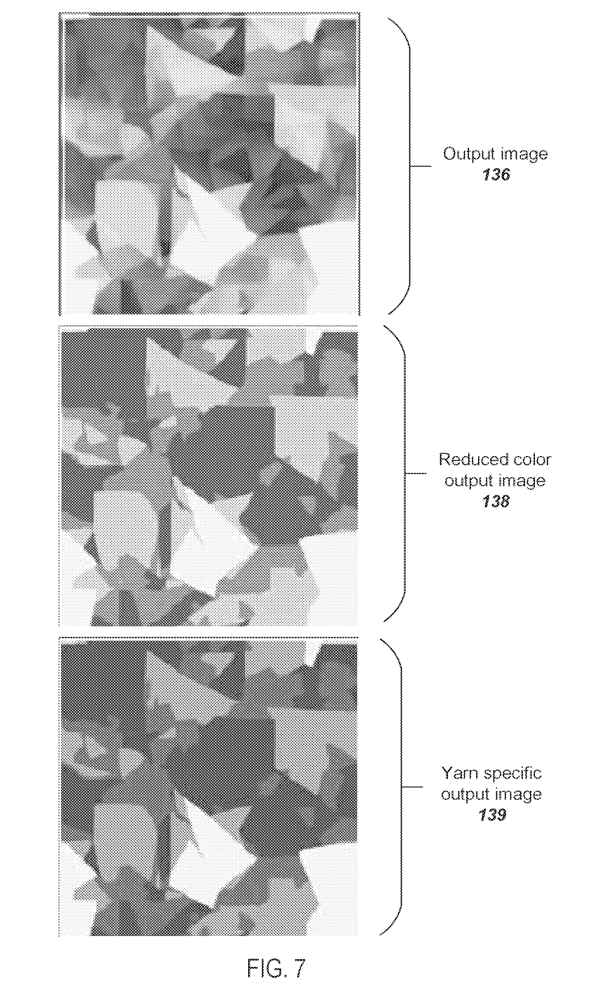

An example output of the production specification generator 114 is illustrated in FIG. 7 for the output image 136 of FIG. 6. The example output image 136 has a relatively wide color palette, with many colors. In an example, the production specification generator 114 can reduce the number of colors in the image (e.g., from output image 136) to an appropriate number for one of the manufacturing tools 124 available. In an example the production specification generator 114 can generate a reduced color output image 138 to reflect the reduced number of colors available. In the example shown, the color count is reduced from the millions of colors available in the output image 136 down to four colors in the reduced color output image 138. In another example, the production specification generator 114 can further modify the colors of the output image 136 or the colors of the reduced color image 138 to those colors specific to the available manufacturing tools 124. In an example, a wallpaper production unit has a certain number of colors of paint and a clothing manufacturing tool has a limited number of dyes available. Similarly for a tufting tool producing flooring product, only certain yarns are available so the production specification generator 114 can generate a yarn specific output image 139. These reduced color images 138, 139 are only examples of the type of image processing which can be used to generate the production specification 140. Other image processing can be performed by the production specification generator 114 such as changing the size of the image, changing the shape of the image, altering the hue, the saturation, the contrast, the color scheme as a whole, and the like. In some implementations, a particular brand of yarn, dye, or paint, can be accessed or a particular color library can be accessed.

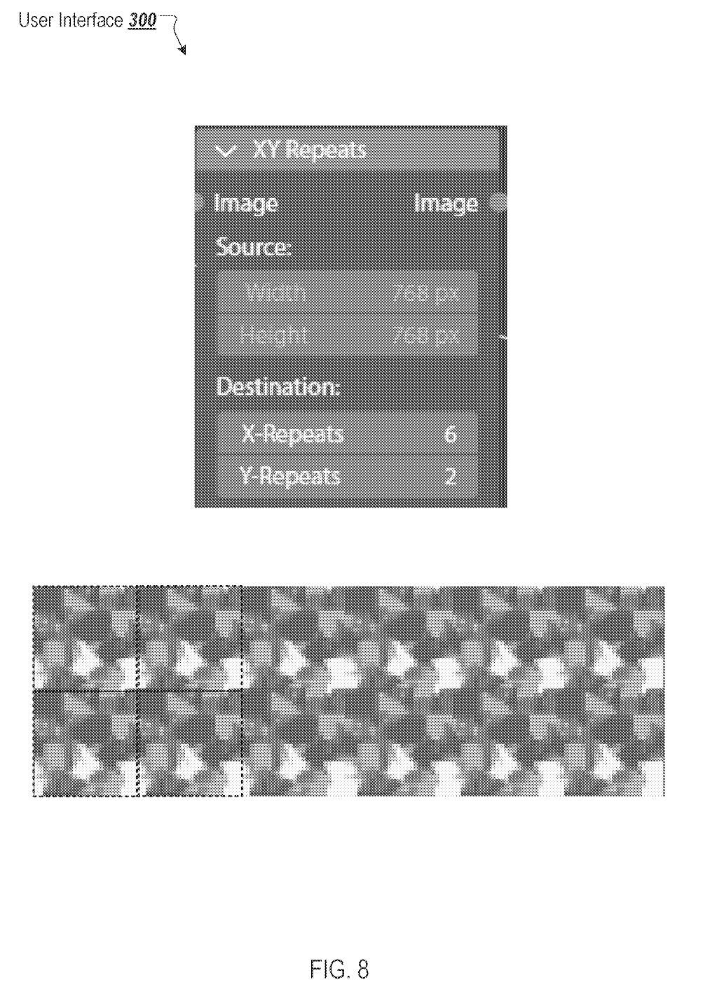

FIG. 8 illustrates how the production design and manufacturing system 100 can display repeating tiles of the output image 134 (or a single tile of the production specification 140) repeated to simulate an entire floor.

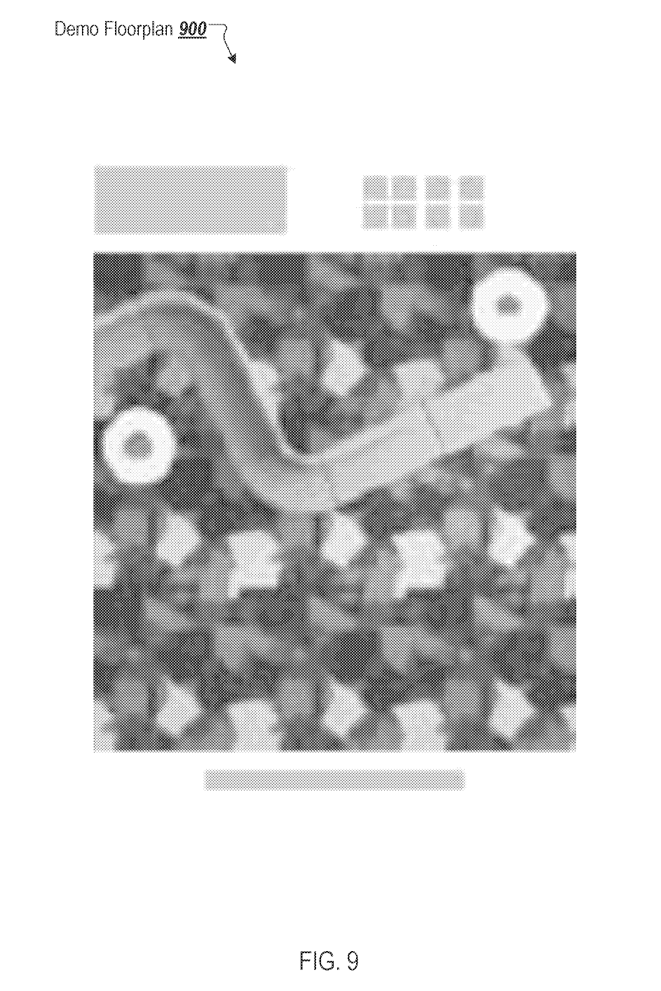

Another aspect of the production specification generator 114 is that it can also produce other documents 142 in addition to the production specification 140. For example, the production specification generator 140 can allow a user to repeat the selected output image 136, or one of the color reduced images 138, 139 as a tile to simulate a full floor covered with that image (see FIG. 8). This task (repetition of design) can also be performed automatically by the production design and manufacturing system 100. This task can aid the designer in, for example, visualizing a complete floor layout. The production specification generator 114 can also output documents 142 to help the designer, such as a demonstration floorplan 900 (see FIG. 9) using any of multiple possibly formats (e.g., pdf, psd, doc, zip, jpg, etc.). The production specification generator 114 also produces a production specification 140. The production specification 140 is not just a product specification, which describes the product (e.g., a flooring tile with a particular pattern) but also describes how to fabricate the product including which manufacturing tools 124 can be used and the inputs to those tools, such as configuration files and tool-specific settings but also the production inputs (e.g., the yarns, the type of pile, the blades or cutters, and how the product can be cut up to forms specific tiles after it has been produced). So the production specification 140 includes all this information and is transmitted to a manufacturing control server 122 which controls the various manufacturing tools 124. In an example, the production specification 140 includes the design, yarn colors, pile heights, etc and also a machine file containing information specific to the manufacturing tool(s) used to fabricate the product. The production specification 140 can include information in various formats for manufacturing tools or for displaying designs such as, for example, the .PCX, .PAT, .2PH, .3PH and MPH file formats

FIG. 8 illustrates an example of a fully fabricated large carpet tile piece in which the modified output image (e.g., the yarn-specific output image 139) is replicated over the entire workpiece for fabrication. FIG. 9 illustrates a demonstration floorplan 900 of the tiles cut up from the example shown in FIG. 8 as they would appear when installed on a floor. The demonstration floorplan 900 is an example of one of the other documents 142 produced by the production specification generator 114. The demonstration floorplan 900 illustrates how a room would appear using the designed flooring product including simulating furniture placed on top of it and gives some idea of the scale by showing a piece of furniture atop the floor.

In an example implementation, a large carpet workpiece is manufactured on a manufacturing tool 124. After being fabricated, the large carpet workpiece needs to be cut for ease of transport an installation as tiles. In this example, the production specification 140 includes a cut list for fabricating carpet tiles from the large carpet workpiece. The cut list describes the shape and size of the flooring tiles to be cut as well as the type of manufacturing tool 124 used. Example shapes include hexagonal, rectangular, square, and triangular and need not be the same as the shape of the output image 136. The production specification 140 can include a type of tool for performing the cutting (e.g., laser cutting tool or blade cutting tool). The production specification 140 can include a list of the motions for the flooring tile and also the motion of the blade.

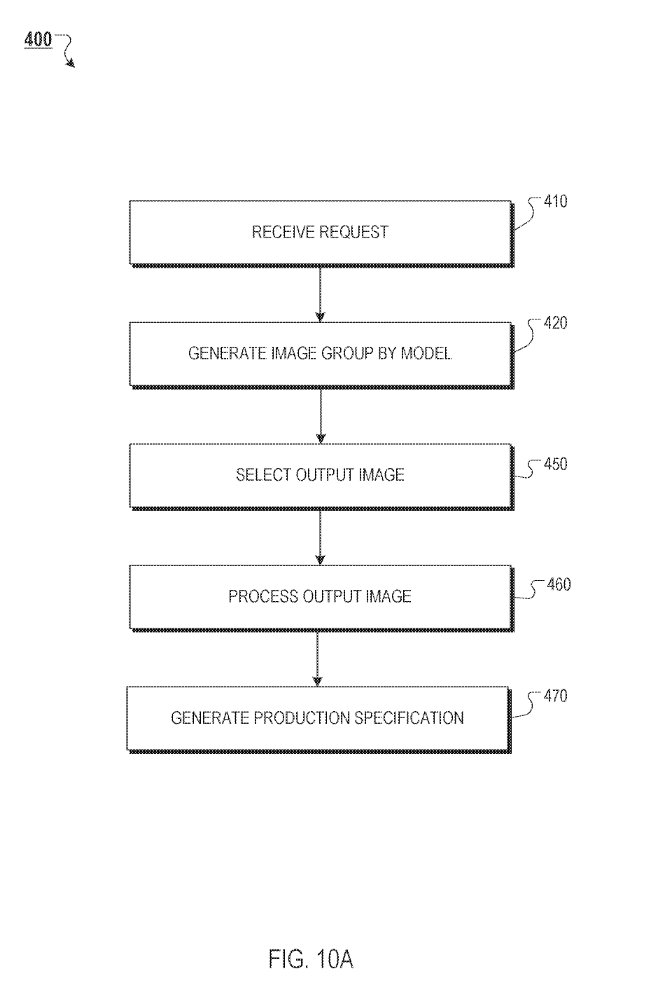

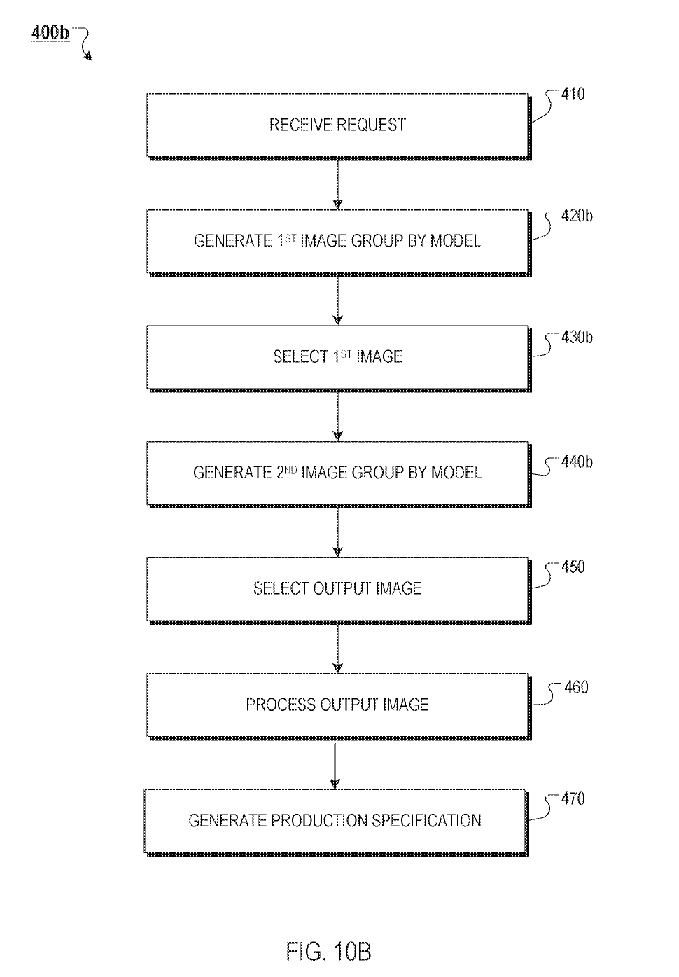

FIGS. 10A and 10B illustrate the steps in the process 400 of generating a design for a flooring product. The overall process for designing and fabricating a product includes receiving a request, generating a group of images, selecting an output image from the group of images, processing the output image, and generating a production specification. In a variation of the process, multiple groups of images are generated in succession with the selected image from the first group forming an input into the generative model for the subsequent image group.

The production design and manufacturing system receives a request to generate a design (operation 410). The request 150 includes a prompt 152 for the image generator 104. The prompt 152 indicates attributes of the output image 136. The request 150 can include a first hyperparameter 154 for the image generator or multiple hyperparameters (e.g., first hyperparameter 154 and second hyperparameters 156). The request 150 can include a first hyperparameter 154 and a range for the first hyperparameter 154 as well as specific values of the first hyperparameter 154 which depend on a number of an iteration of the image generator in the overall process. The image generator includes a generative machine learning model for generating images using the prompt as an input. The image generator can include a first model, a second model and also other, additional models. An example model type is a diffusion model which has been trained to gradually evolve from random noise towards some image. The model can be been trained prior to the use in this process involving an image database 160. The images in the image database 160 have been labelled or categorized so that each image of the image database 160 has metadata associated with it which is used in training the generative machine learning model of the image generator 104.

The image generator generates a first group of images based on the prompt and, optionally, any hyperparameters from the request (operation 420). In an example implementation, the prompt 152 can be encoded as a vector. The images from the image database 160 have also been encoded as vectors which take into account the metadata associated with each image (e.g., a label or a descriptor). The model has been trained, based on the image database 160 to associate certain features or aspects of each image so that it can produce, based on the prompt 152, new images. In an example diffusion model with a sampling method (e.g., the Designer model with the DPM++2M Karras sampling method), a set of randomly assigned pixels is gradually evolved to a final image based on the parameters in the model which were determined after training the model. Another example is to start with a small image of only a few pixels (e.g., 8X8) which are randomly assigned and then to evolve the image towards a final output image while increasing the image size gradually (e.g., 8X8 to 16X16, then to 32X32, etc.). Another example is to receive an input image as the prompt 152 and to add noise to the input image to introduce some randomness, and then evolve noise-added images further from that point. There are many models and methods for generating images, and the details supplied here are only examples of such models and methods and are not meant to be limiting. The image generator generates a group of images using a generative machine learning model.

The production design and manufacturing system or the user selects an output image from the group of images (operation 450). In example implementations, the production design and manufacturing system ranks each of the group of images according to some metric or other criteria. The production design and manufacturing system can then select the image with the highest metric or the best criteria from the first group of images. An example metric is a color matching metric for comparing closely the colors of each of the group of images match the colors of the prompt. For example, if the prompt is an image using multiple colors and a fraction of pixels are assigned to each of the multiple colors, then a color match could compare the fraction of pixels for each color of the prompt image with the fraction of pixels for that same color in each of the group of generated images. Alternatively, the user can select one image of the first group of images by using a user interface. In the example user interface as shown in FIGS. 3-6, the user can select the output image by, for example, clicking on it. An output image is selected from among the group of images. The production design and manufacturing system or the user selects an output image among the group of images. The output image is sent to the production specification generator of the production server.

The production specification generator processes the output image (operation 460). The production specification generator can generate additional images by applying operations to the output image. The production specification generator maps aspects of the output image to a production specification corresponding to the to-be-manufactured product. An example image processing operation is a reduction in the number of colors (the color palette) from a large number (e.g., millions) to a more manageable number (e.g. 4 or 8). The reduced color palette corresponds more accurately, for example, to the limited number of yarns/paints/dyes available for a manufacturing tool. Another example image processing operation is modifying the hue, the saturation, or the contrast amongst the colors of the output image.

Once the processing of the output image is completed, the production specification generator generates the production specification (operation 470). The production specification includes the information for fabricating the product including specific instructions for specific tools. The production specification can also include instructions for multiple tools if multiple tools are available so that, in a subsequent operation, the manufacturing control server can evaluate which tool to use for fabricating the product. Having multiple options available will help optimize utilization of the available manufacturing tools. As part of generating the production specification, other documents can also be generated such a demonstration brochures or files, images, compressed images, and the like. The production specification generator maps aspects of the output image (or the processed output image) to a production specification. The production specification generator then transmits the production specification to the manufacturing control server which generates the to-be-manufactured product by a manufacturing tool using the production specification.

In an alternative implementation, illustrated in FIG. 10B, multiple rounds of image generation and selection take place before the output image is selected. In the example illustrated in FIG. 10B, two iterations of the image generation are shown, but one, two, or more iterations of image generation and image selection can occur before the selection of the output image.

In this example alternative method, the image generator generates a first group of images (operation 420b) based on the prompt and using a first generative machine learning model 170-1. The image generator includes a first generative machine learning model 170-1 and a second generative machine learning model 170-2. The prompt is submitted to the first generative machine learning model 170-1. The image generator generates a first group of images using the generative machine learning model and using the prompt as an input. In an example, a first hyperparameter and the prompt are submitted to the first generative machine learning model 170-1 to generate the first group of images.

The production design and manufacturing system selects a first image from the first group of images (operation 430b). The selection operation of a first image from the first group of image is substantially the same as the selection of the output image from the group of images described earlier in reference to FIG. 10A (operation 450).

In the example alternative implementation, the image generator generates a second set of images (operation 440b). The image generator includes a second generative machine learning model 170-2. The image generator generates a second group of images using a second generative machine learning model 170-2 and based on the first image as an input and can include a second hyperparameter. The image generator receives as input the first image (selected by the production design and manufacturing system or by a user) and can also receive as input the prompt and a hyperparameter. In an example, certain hyperparameters can be included in the image generator only during the generation of the second group of images using the second generative machine learning model 170-2 and not used by the first generative machine learning model 170-1. In an example, a second hyperparameter is determined for use with the second generative machine learning model 170-2. The selected first image is submitted along with the second hyperparameter to the second generative machine learning model 170-2. The second generative machine learning model 170-2 generates a second group of images based on the first image and the second hyperparameter. The second hyperparameter includes a noise level. The noise level determines an amount of noise added to the first image by the second generative machine learning model 170-2 when generating the second group of images.

If additional refinement is desired, several cycles of image selection and generation can be performed and certain hyperparameters can only be included at later stages but not in initial stages of the generation of each group of images. In these example implementations, the output image is the final image selected from the final generated group of images and the other selected images are intermediate images (e.g., a first intermediate image, a second intermediate image, etc.). The intermediate images are used as inputs to the subsequent generation of the subsequent group of images. These additional cycles can be used, for example, to generate several closely related designs which can be evaluated by a human or which can be ranked by some metric or calculation. In an example, an initial set of designs can be quickly and easily created with a very similar set of shapes, so that slight color variations may be explored. In another examples, the same color palette may be used but different shapes may be explored. Thus, by invoking additional iterations of intermediate image generation by the generative machine learning models, the design process can be made easier, faster, and with reduced resources.

In the alternative implementation, the output image is selected (operation 450) from the second group of images. Selecting the output image, processing the output image, and generating the production specification are substantially the same as those described earlier with reference to FIG. 10A, the descriptions are not repeated.

Before the present subject matter is described in detail, it is to be understood that this disclosure is not limited to the particular embodiments described, as such may, of course, vary. The terminology used herein is for the purpose of describing particular embodiments only, and is not intended to be limiting, given that the scope of the present disclosure will be limited only by the appended claims.

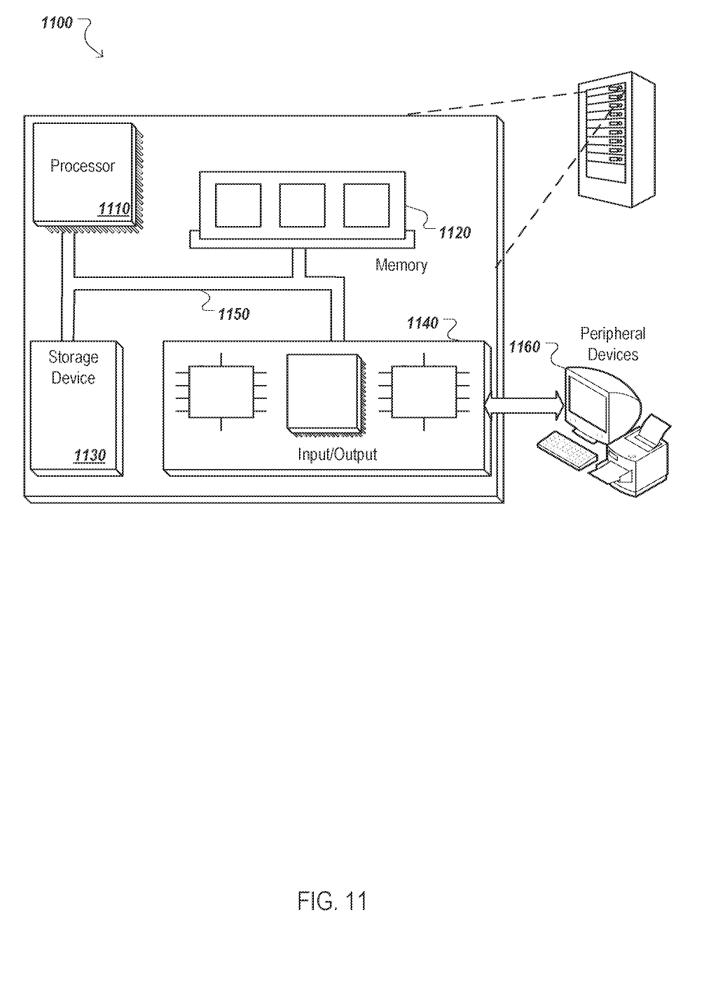

FIG. 11 is block diagram of an example computer system 1100 that can be used to perform operations described above. The system 1100 includes a processor 1110, a memory 1120, a storage device 1130, and an input/output device 1140. Each of the components 1110, 1120, 1130, and 1140 can be interconnected, for example, using a system bus 1150. The processor 1110 is capable of processing instructions for execution within the system 1100. In some implementations, the processor 1110 is a single-threaded processor. In another implementation, the processor 1110 is a multi-threaded processor. The processor 1110 is capable of processing instructions stored in the memory 1120 or on the storage device 1130.

The memory 1120 stores information within the system 1100. In one implementation, the memory 1120 is a computer-readable medium. In some implementations, the memory 1120 is a volatile memory unit. In another implementation, the memory 1120 is a non-volatile memory unit.

The storage device 1130 is capable of providing mass storage for the system 1100. In some implementations, the storage device 1130 is a computer-readable medium. In various different implementations, the storage device 1130 can include, for example, a hard disk device, an optical disk device, a storage device that is shared over a network by multiple computing devices (e.g., a cloud storage device), or some other large capacity storage device.

The input/output device 1140 provides input/output operations for the system 1100. In some implementations, the input/output device 1140 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to peripheral devices 1160, e.g., keyboard, printer and display devices. Other implementations, however, can also be used, such as mobile computing devices, mobile communication devices, set-top box television client devices, etc.

Although an example processing system has been described in FIG. 11, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

As used herein and in the appended claims, the singular forms “a,” “an,” and “the” include plural referents unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments can be recited in or added to the claims, as well as negative limitations that define the inventive scope of the claims by features, functions, steps, or elements that are not within that scope.

What is claimed is:

1. A computer-implemented method comprising:
receiving a request to generate an image corresponding to a design of a to-be-manufactured product, wherein the request comprises a prompt indicating attributes of the image;
generating, using a generative machine learning model and using the prompt as an input, a plurality of images;
selecting an output image among the plurality of images as the design of the to-be-manufactured product;
mapping aspects of the output image to a production specification corresponding to the to-be-manufactured product; and
generating, by a manufacturing tool, the to-be-manufactured product using the production specification.

2. The method of claim 1, wherein generating the plurality of images and selecting the output image comprises:
submitting the prompt to a first generative machine learning model;
generating, using the first generative machine learning model and using the prompt as an input, a first plurality of images;
selecting a first image among the first plurality of images;
generating, using a second generative machine learning model, a second plurality of images based on the first image; and
selecting the output image from the second plurality of images.

3. The method of claim 2, wherein the first and second generative machine learning models comprise diffusion models trained using a plurality of training images and wherein the plurality of training images comprises product images from a product catalog and public images corresponding to publicly accessible images.

4. The method of claim 2, wherein the request comprises a first hyperparameter of the first or second generative machine learning model, and wherein the first hyperparameter is submitted to the first or second generative machine learning model along with the prompt to generate the first or second plurality of images.

5. The method of claim 4, wherein the first hyperparameter comprises at least one of a number of steps for a sampling method or a creativity level, wherein the creativity level corresponds to a distance metric between an encoding of the prompt and an image encoding of each image of the first or second plurality of images.

6. The method of claim 4, wherein generating the second plurality of images comprises:
determining a second hyperparameter for the second generative machine learning model;
submitting the first image and the second hyperparameter to the second generative machine learning model; and
generating, by the second generative machine learning model and based on the first image and the second hyperparameter, the second plurality of images.

7. The method of claim 6, wherein the second hyperparameter comprises a noise level, and wherein the noise level determines an amount of noise added to the first image by the second generative machine learning model when generating the second plurality of images.

8. The method of claim 1, wherein the prompt comprises at least one of a text prompt or an image prompt.

9. The method of claim 1, wherein the to-be-manufactured product is a carpet tile and the production specification comprises data for attributes of the carpet tile including, for each pixel of the output image, at least one of a yarn type, a yarn color, a pile type, and a pile height.

10. The method of claim 9, wherein the production specification further comprises a tufting tool, a cutting tool, a cut list, a tile shape, a tile dimension, and an overall dimension.

11. A system for producing a production specification and a to-be-manufactured product comprising:
a production server;
a manufacturing control server; and
an image generator;
wherein the image generator is configured to:
receive a request comprising a prompt indicating attributes of an output image;
generate, using a generative machine learning model with the prompt as an input, a plurality of images;
select the output image from the plurality of images;
wherein the production server is configured to:
map aspects of the output image to the production specification corresponding to the to-be-manufactured product; and
wherein the manufacturing control server is configured to:
generate, by one or more manufacturing tools, the to-be-manufactured product using the production specification.

12. The system of claim 11, wherein the image generator is further configured to:
submit the prompt to a first generative machine learning model;
generate, using the first generative machine learning model and using the prompt as an input, a first plurality of images;
select a first image among the first plurality of images;
generate, using a second generative machine learning model, a second plurality of images based on the first image; and
select the output image from the second plurality of images.

13. The system of claim 12, wherein the first and second generative machine learning models comprise diffusion models trained using a plurality of training images and wherein the plurality of training images comprises product images from a product catalog and public images corresponding to publicly accessible images.

14. The system of claim 12, wherein the request comprises a first hyperparameter of the first or second generative machine learning model, and wherein the first hyperparameter is submitted to the first or second generative machine learning model along with the prompt to generate the first or second plurality of images.

15. The system of claim 14, wherein the first hyperparameter comprises at least one of a number of steps for a sampling method or a creativity level, wherein the creativity level corresponds to a distance metric between an encoding of the prompt and an image encoding of each image of the first or second plurality of images.

16. The system of claim 14, wherein the image generator is further configured to:
determine a second hyperparameter for the second generative machine learning model;
submit the first image and the second hyperparameter to the second generative machine learning model; and
generate, by the second generative machine learning model and based on the first image and the second hyperparameter, the second plurality of images.

17. The system of claim 16, wherein the second hyperparameter comprises a noise level, and wherein the noise level determines an amount of noise added to the first image by the second generative machine learning model when generating the second plurality of images.

18. The system of claim 11, wherein the prompt comprises at least one of a text prompt or an image prompt.

19. The system of claim 11, wherein the to-be-manufactured product is a carpet tile and the production specification comprises data for attributes of the carpet tile including, for each pixel of the output image, at least one of a yarn type, a yarn color, a pile type, and a pile height.

20. The system of claim 19, wherein the production specification further comprises a tufting tool, a cutting tool, a cut list, a tile shape, a tile dimension, and an overall dimension.
